(19) United States
(12) Patent Application Publication
(10) Pub. No.: US 2006/0221055 A1
(43) Pub. Date: Oct. 5, 2006

(54) Wireless mouse

(76) Inventors: An-Sheng Chang, Taipei Hsien (TW); Yi Ming Lee, Taipei Hsien (TW)

Correspondence Address: Morton J. Rosenberg, Esq.;Rosenberg, Klein & Lee, Suite 101, 3458 Ellicott Center Drive, Ellicott City, MD, 21043, US

(21) Appl. No.: 11/098,444

(22) Filed: Apr. 5, 2005

(51) Int. Cl. G09G 5/08

(52) U.S. Cl. 345/163

(57) ABSTRACT

A wireless mouse can self-generate and self-accumulate electrical energy by utilizing the kinetic energy during user shaking the mouse. The wireless mouse has a shell, a command device, a rechargeable battery and a generating device. The command device is assembled in the shell. The command device has a controller for detecting a position of the shell and producing an electronic signal, a demodulator for transforming the electronic signal to a wireless signal, and an antenna for transmitting the wireless signal. The rechargeable battery is assembled in the shell for supplying electrical energy to the command device. The generating device is assembled in the shell and has a linear generator which is electrically connecting to the rechargeable battery.

### BACKGROUND OF THE INVENTION

1. Field of the Invention

The present invention relates in general to a wireless mouse, and more particularly to a wireless mouse having the functions of self-generating and self-accumulating electrical energy by utilizing the kinetic energy during moving itself for meeting the need electric power.

2. Description of the Related Art

The invention of the mouse makes computer operating very easily. For improving the inconvenience of the wires of the mouse during user operating, a wireless mouse has therefore been proposed. The operation of a wireless mouse needs a battery for sending an electrical signal to computer through a wireless module. A battery usually is assembled in the wireless mouse for maintaining the consuming electric power. However, frequent replacement of the battery still cause the user great inconvenience and extra expense. Moreover, the discarded battery wastes natural resources and produces environmental pollution.

To improve the disadvantages mentioned above, U.S. Pat. No. 6,686,903 disclosures a “wireless mouse capable of generating and accumulating electrical energy”. Referring to the FIG. 1, the conventional wireless mouse comprises a rolling ball 123, a first rolling wheel 125, a second rolling wheel 127, an auxiliary wheel 129, a first gear-wheel 130 and a second gear-wheel 132. The first rolling wheel 125 longitudinally props up the rolling ball 123 in order to detect the displacement of wireless mouse projected along the X-axis. On the other hand, the second rolling wheel 127 transversely props up the rolling ball 123 in order to detect the displacement of the wireless mouse projected along the Y-axis. The first gear-wheel 130 is connected with the first rolling wheel 125 coaxially and therefore turn with each other. The second gear-wheel 132 is connected with the second rolling wheel 127 coaxially and therefore turn with each other. The auxiliary wheel 129, the first rolling wheel 125 and the second rolling wheel 127 prop up the rolling ball 123 so that the rolling ball 123 is kept in a certain rolling position. The wireless mouse further comprises a first generating device 115 and a second generating device 119. The first generating device 115 is connected to a third gear-wheel 117 which is engaged with the first gear-wheel 130 for transforming dynamic energy into electrical energy. The second generating device 119 is connected to a fourth gear-wheel 121 with the second gear-wheel 132 for transforming dynamic energy into electrical energy. The electrical energy is outputted to a power storage device 131.

The conventional wireless mouse still has disadvantages as followed:

1. The generating devices are drove by gear-wheel which increases the loading of gear-wheel, and user needs additional force when operating for providing the kinetic energy to the generating devices.

2. The two sets of generating devices increases the total weight, which not only causing operation not easily, but also increasing the loading of wrist. If there is only one set of generating device, it cannot balance the loading of gear-wheel.

Therefore, the wireless mouse according to the prior art still has some inconvenience and disadvantages.

The inventor, after investigation and research, thus provides the present invention of logical designing for improving the above-mentioned imperfections.

### SUMMARY OF THE INVENTION

An object of the present invention is to provide a wireless mouse which can utilize the kinetic energy of itself when moving, and self-generating and self-accumulating electrical energy for supplying itself, so that conforming the requirement of environmental protection.

Another object of the present invention is to provide a wireless mouse which fulfill the prerequisite of not aggravate additional burden to user, and fully utilize the kinetic energy of mouse moving, to have the functions of generating and accumulating electrical energy.

In order to achieve the above objects, the present invention provides a wireless mouse comprising a shell, a command device, a rechargeable battery and a generating device. The command device is assembled in the shell. The command device has a controller for detecting a position of the shell and producing an electronic signal, a demodulator for transforming the electronic signal to a wireless signal, and an antenna for transmitting the wireless signal. The rechargeable battery is assembled in the shell for supplying electrical energy to the command device. The generating device is assembled in the shell and has a linear generator which is electrically connecting to the rechargeable battery.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is an inner top view of a wireless mouse of prior art;

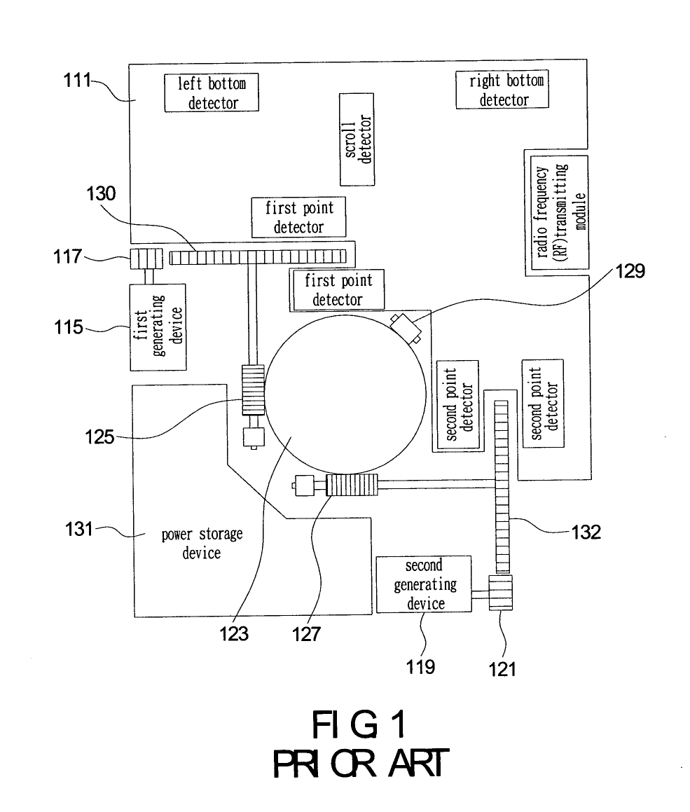

FIG. 2 is a perspective view of a wireless mouse according to the present invention;

FIG. 3 is a block diagram of the wireless mouse according to the present invention; and

FIG. 4 is a circuit diagram of a generator according to the present invention.

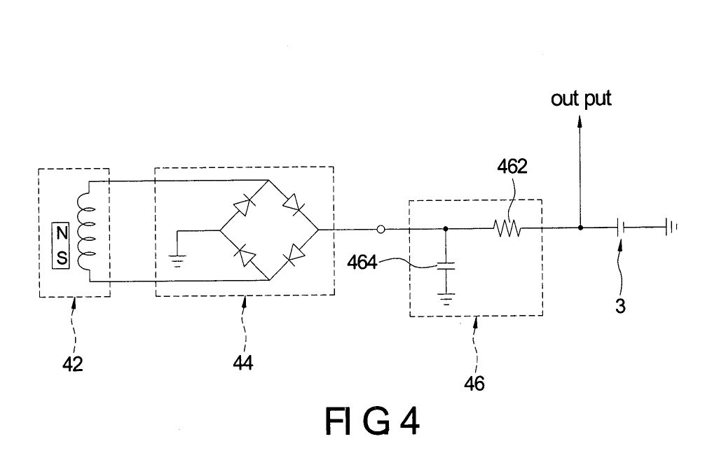

### DESCRIPTION OF THE PREFERRED EMBODIMENT

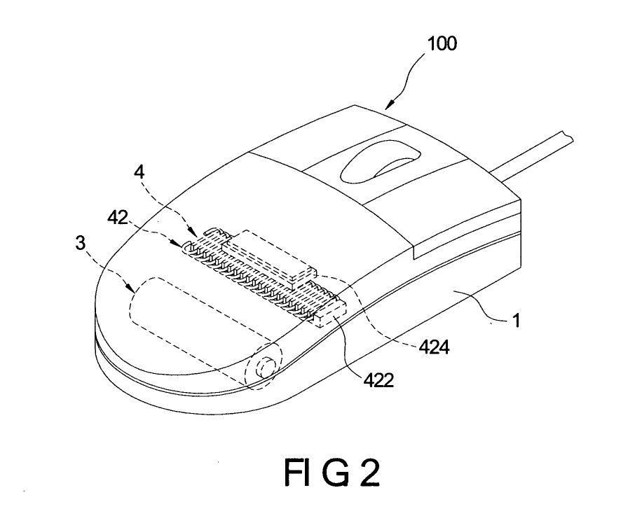

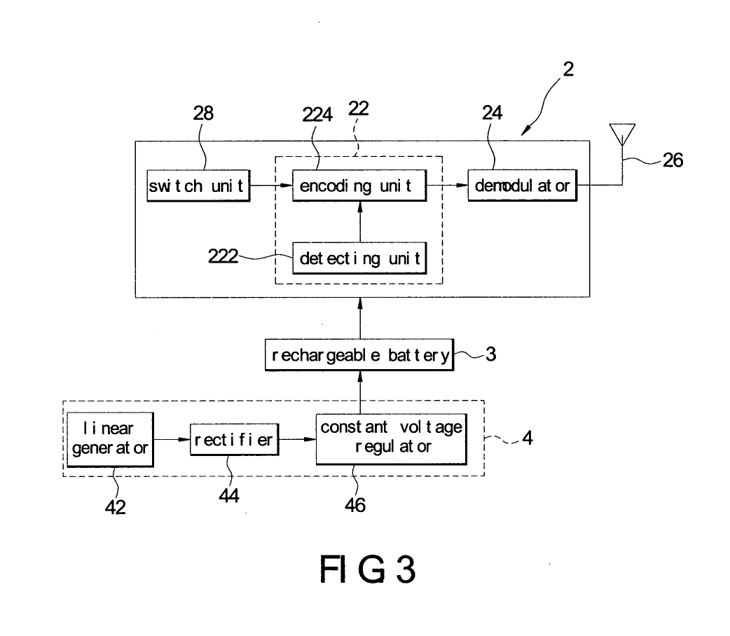

Please refer to the FIGS. 2 and 3, which are a perspective view and block diagram of a wireless mouse according to the present invention. The present invention provides a wireless mouse 100 that is used for controlling a cursor moving on a monitor of computer. In the preferred embodiment, the wireless mouse 100 comprises a shell 1, a command device 2, a rechargeable battery 3 and a regenerating device 4. The shell 1 is for being gripped by user to move the wireless mouse 100, which is usually mounted with a switch unit, such as a plurality of buttons and a rolling-wheel. However, such illustrated shape does not limit the present invention.

The command device 2 is assembled in the shell 1 and is usually is assembled on a PCB (not shown). It's function is detecting the moving condition of the wireless mouse 100 and producing a corresponding signal, then transmitting to computer. The command device 2 has a controller 22, a demodulator 24, an antenna 26 and a switch unit 28. The controller 22 is used to detect a position of the shell 1 and produce an electronic signal. Then, the electronic signal is transmitted to the demodulator 24. The demodulator 24 receives the electronic signal and transforms the electronic signal to a wireless signal. The wireless signal is transmitted to the antenna 26 and is transmitted to a receiver of computer.

In detail, the controller 22 comprises a detecting unit 222 and an encoding unit 224. The detecting unit 222 can be a mechanical type detecting unit or an optical type detecting unit, for example a encoding rolling-wheel, a raster device, or image sensor, whose function is detecting movement of the wireless mouse 100 and transmitting the detected data to the encoding unit 224. The encoding unit 224 is used to sample the detected data from the detecting unit 222 or the switch unit 28 and process encoding.

The function of the demodulator 24 is transforming the encoded signal from the encoding unit 224 to comply with the format of the wireless transmission protocol, for example infrared rays, or bluetooth. Then transmitting to computer by the antenna 26. The switch unit 28 is coupled with switches under the buttons of the shell 1.

The rechargeable battery 3 is assembled in the shell 1 and is connected to the command device 2 for supplying electrical energy to the command device 2.

The generating device 4 is assembling in the shell 1. The generating device 4 has a linear generator 42 which is electrically connecting to the rechargeable battery 3, a rectifier 44 and a constant voltage regulator 46. In this embodiment, the linear generator 42 comprises a coin 422 arranged in a spreading manner and a flat magnet 424 that is movably disposed above the coin 422. The magnet 424 provides a surrounding magnetic field. When the magnet 424 slides on the coin 422, the magnetic flux changes and the coin 422 produces an induced electromotive force (voltage), therefore produces an induced current. In this embodiment, the linear generator is shown as a sketch figure. For ensuring the magnet 424 slides on the coin 422, guiding device can be formed on two sides of the coin 422, such as guiding rails. Further, a crashproof device can be added to two ends of the coin 422, such as magnet, or quake-absorbing element.

The rectifier 44 of the generating device 4 is electrically connecting to the linear generator 42, and is composed of diodes, which are used to prevent induced current from flowing to a negative electrode of the rechargeable battery 3, and make the induced current to flow a positive electrode of the rechargeable battery 3 for recharging. In this embodiment, the rectifier 44 is a bridge rectifier, but that is not limited.

The constant voltage regulator 46 of the generating device 4 is used for stabilizing the voltage. The constant voltage regulator 46 has two ends, one end is connected to the rectifier 44 and the other end is connected to the rechargeable battery 3. In this embodiment, the constant voltage regulator 46 comprises a resistance 462 and a capacitance 464. The resistance 462 has two ends, one end is connected to the rectifier 44 and the other end is connected to the rechargeable battery 3. The capacitance 464 has two ends, one end is connected to the rectifier 44 and the other end is grounding.

The present invention utilizes the kinetic energy of the mouse itself when moving, and self-generating and self-accumulating electrical energy for supplying itself, so that conforming the requirement of environmental protection. When user operates the wireless mouse, the wireless mouse is moved right and left frequently and the magnet 424 of the linear generator 42 moves on the coin 422, therefore produces induced current and generates electrical power. The present invention utilizes the principle of magnetic induce, which can charge the battery anytime and does not need to replace battery, therefore can prolong the lifespan of the wireless mouse. The present invention surely can co-operate with the original recharge way by plug, which is selectable by the user.

The present invention provides the linear generator, which does not increase resistance of roller of the wireless mouse, and does not increase additional burden to user. The structure utilizes the kinetic energy during user shaking the mouse to transform electrical energy, so that make the wireless mouse having functions of self-generating and self-accumulating electrical energy.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A wireless mouse, comprising:
a shell;
a command device, assembled in said shell, and having a controller for detecting a position of said shell and producing an electronic signal, a demodulator for transforming said electronic signal to a wireless signal, and an antenna for transmitting said wireless signal; and
a rechargeable battery, assembled in said shell for supplying electrical energy to said command device; and
a generating device, assembling in said shell, said generating device having a linear generator which is electrically connecting to said rechargeable battery.

2. The wireless mouse as in claim 1, wherein said controller having a detecting unit and an encoding unit.

3. The wireless mouse as in claim 2, wherein said detecting unit is a mechanical type detecting unit.

4. The wireless mouse as in claim 2, wherein said detecting unit is an optical type detecting unit.

5. The wireless mouse as in claim 1, wherein said command device further has a switch unit electrically connecting to said encoding unit.

6. The wireless mouse as in claim 1, wherein said liner generator has a coin arranged in a spreading manner and a flat magnet movably disposed above said coin.

7. The wireless mouse as in claim 1, wherein said generating device further comprises a rectifier electrically connecting to said linear generator.

8. The wireless mouse as in claim 7, wherein said rectifier is a bridge rectifier.

9. The wireless mouse as in claim 7, wherein said generating device further comprises a constant voltage regulator, and said constant voltage regulator has two ends, one end is connected to said rectifier and the other end is connected to said rechargeable battery.

10. The wireless mouse as in claim 9, wherein said constant voltage regulator comprises a resistance and a capacitance, and wherein said resistance has two ends, one end is connected to said rectifier and the other end is connected to said rechargeable battery, and wherein said capacitance has two ends, one end is connected to said rectifier and the other end is grounding.
